(19) United States
(12) Patent Application Publication
(10) Pub. No.: US 2025/0095531 A1
(43) Pub. Date: Mar. 20, 2025

(54) ELECTRONIC DEVICE FOR ADJUSTING DISPLAY COLOR AND CONTROL METHOD THEREFOR

(71) Applicants: SAMSUNG ELECTRONICS CO., LTD., Suwon-si (KR); ULSAN NATIONAL INSTITUTE OF SCIENCE AND TECHNOLOGY, Ulsan (KR)

(72) Inventors: Guiwon SEO, Suwon-si (KR); Minjeong Ko, Ulsan (KR); Youngshin Kwak, Ulsan (KR); Jonghwan Kim, Suwon-si (KR); Youngsu Moon, Suwon-si (KR)

(73) Assignees: SAMSUNG ELECTRONICS CO., LTD., Suwon-si (KR); ULSAN NATIONAL INSTITUTE OF SCIENCE AND TECHNOLOGY, Ulsan (KR)

(21) Appl. No.: 18/962,798

(22) Filed: Nov. 27, 2024

Related U.S. Application Data
(63) Continuation of application No. PCT/KR2023/005236, filed on Apr. 18, 2023.

(30) Foreign Application Priority Data
May 31, 2022 (KR) 10-2022-0067101

(51) Int. Cl. G09G 3/20; G06T 7/90

(52) U.S. Cl. CPC G09G 3/2003; G06T 7/90; G06T 2200/24; G06T 2207/10024; G06T 2207/20092; G09G 2320/0666; G09G 2354/00

(57) ABSTRACT

An electronic device is disclosed. The electronic device includes a display; memory, the memory storing a first spectrum information of the display and information on a plurality of color matching functions (CMFs); and at least one processor connected with the memory, wherein the at least one processor is configured to: obtain picture spectrum information of a test image based on a second spectrum information of an external display device displaying the test image, obtain test images based on the picture spectrum information, the first spectrum information, and the information on the plurality of CMFs, wherein the test images comprise a respective test image for each of the plurality of CMFs corresponding to the test image, and control the display to display the test images.

### CROSS-REFERENCES TO RELATED APPLICATIONS

This application is a continuation of International Application No. PCT/KR2023/005236, filed on Apr. 18, 2023, in the Korean Intellectual Property Office, which claims priority from Korean Patent Application No. 10-2022-0067101, filed on May 31, 2022, in the Korean Intellectual Property Office, the disclosures of which are incorporated herein by reference in their entireties.

### BACKGROUND

### 1. Field

The disclosure relates to an electronic device and a control method therefor, and more particularly to an electronic device that corrects color of a display and a control method therefor.

### 2. Description of Related Art

With developments in electronic technology, electronic devices of various types are being developed and distributed. Specifically, display devices used in various locations such as homes, offices, and public spaces have recently been under continuous development for several years.

A method of expressing color accurately in a display is based on a CIE1931 standard enacted in 1931. That is, a color of a display may be reproduced by applying a technology for accurately expressing color which is quantified in the standard.

In addition, additional standards or research to substitute the CIE1931 standard itself is ongoing. There are standards such as CIE1964, CIE1976, and CIECAM2002 and proposals, but there is little likelihood of the above being adopted directly into a display device due to non-linearity and high complexity of the relevant standards.

Displays adjusted based on the CIE1931 standard have had no significant issues in a narrow color gamut display. Because the narrow color gamut display expresses a wide spectrum in each device, people do not observe a great deviation even if CMF is relatively inaccurate. However, with wide color gamut displays being developed recently and new device technology such as OLED, micro LED, and the like being introduced, there is a problem of different people observing a large color difference when the standard of related art is used as is. That is, with wide color gamut displays, a phenomenon of each user recognizing the same color as different colors has occurred.

### SUMMARY

The disclosure addresses the above-mentioned needs, and an object of the disclosure is in providing an electronic device which prevents a color mismatch phenomenon by identifying CMF information which is most suitable to a user in a wide color gamut display and a control method therefor.

According to an embodiment an electronic device includes a display; memory, the memory storing a first spectrum information of the display and information on a plurality of color matching functions (CMFs); and at least one processor connected with the memory, wherein the at least one processor is configured to: obtain picture spectrum information of a test image based on a second spectrum information of an external display device displaying the test image, obtain test images based on the picture spectrum information, the first spectrum information, and the information on the plurality of CMFs, wherein the test images comprise a respective test image for each of the plurality of CMFs corresponding to the test image, and control the display to display the test images.

According to an embodiment, a control method of an electronic device includes identifying a first spectrum information of a display comprised in the electronic device; obtaining picture spectrum information of a test image based on a second spectrum information of an external display device displaying the test image; obtaining test images based on the picture spectrum information, the first spectrum information, and information on a plurality of color matching functions (CMFs), wherein the test images comprise a respective test image for each of the plurality of CMFs corresponding to the test image; and displaying the test images on the display comprised in the electronic device.

In addition, according to an embodiment, a non-transitory computer-readable medium storing computer instructions includes one or more instructions that, when executed, cause at least one processor of an electronic device to: identify a first spectrum information of a display comprised in the electronic device; obtain picture spectrum information of a test image based on a second spectrum information of an external display device displaying the test image; obtain test images based on the picture spectrum information, the first spectrum information, and information on a plurality of color matching functions (CMFs), wherein the test images comprise a respective test image for each of the plurality of CMFs corresponding to the test image, display the test images on the display comprised in the electronic device.

### BRIEF DESCRIPTION OF THE DRAWINGS

The accompanying drawings herein are incorporated into and form part of the specification, illustrate embodiments consistent with the present disclosure, which are used in conjunction with the specification to explain the principles of the present disclosure and do not constitute an undue limitation of the present disclosure.

FIG. 1 is a diagram illustrating spectrum characteristics of a display.

FIG. 2 is a block diagram illustrating an exemplary configuration of an electronic device according to an embodiment.

FIG. 3A and FIG. 3B are diagrams illustrating spectrum information according to an embodiment.

FIG. 4 is a diagram illustrating a test image obtaining method for CMF according to an embodiment.

FIG. 5 is a diagram illustrating picture spectrum information of a test picture according to an embodiment.

FIG. 6 is a diagram illustrating CMF information according to an embodiment.

FIG. 7 is a diagram illustrating a test image obtaining method for CMF according to an embodiment.

FIG. 8 is a diagram illustrating a process of obtaining test images for a plurality of CMFs according to an embodiment.

FIG. 9 is a diagram illustrating a process of obtaining test images for a plurality of CMFs according to an embodiment.

FIG. 10 is a diagram illustrating schematically a process for selecting an optimal CMF of a user according to an embodiment.

FIG. 11A to FIG. 11E are diagrams illustrating an example of a UI screen according to an embodiment.

FIG. 12 is a diagram illustrating a process for correcting an input picture according to an embodiment.

FIG. 13 is a diagram illustrating a process for correcting an input picture according to an embodiment.

FIG. 14 is a diagram illustrating an embodiment of an electronic device according to an embodiment of the disclosure.

### DETAILED DESCRIPTION

The disclosure will be described in detail below with reference to the accompanied drawings.

Terms used in the disclosure will be briefly described, and the disclosure will be described in detail.

The terms used in describing embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure.

Terms such as “first,” and “second” may be used in describing various elements, but the elements are not to be limited by the terms. The terms may be used only to distinguish one element from another.

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The expression at least one of A or B is to be understood as indicating any one of “A” or “B” or “A and B.”

The term “module” or “part” used herein perform at least one function or operation, and may be implemented with a hardware or software, or implemented with a combination of hardware and software. In addition, a plurality of “modules” or a plurality of “parts,” except for a “module” or a “part” which needs to be implemented to a specific hardware, may be integrated in at least one module and implemented as at least one processor (not shown).

Embodiments of the disclosure will be described in detail with reference to the accompanying drawings to aid in the understanding of those of ordinary skill in the art. However, the disclosure may be implemented in various different forms and it should be noted that the disclosure is not limited to the embodiments described herein. Further, in the drawings, parts not relevant to the description may be omitted, and like reference numerals may be used to indicate like elements throughout the disclosure.

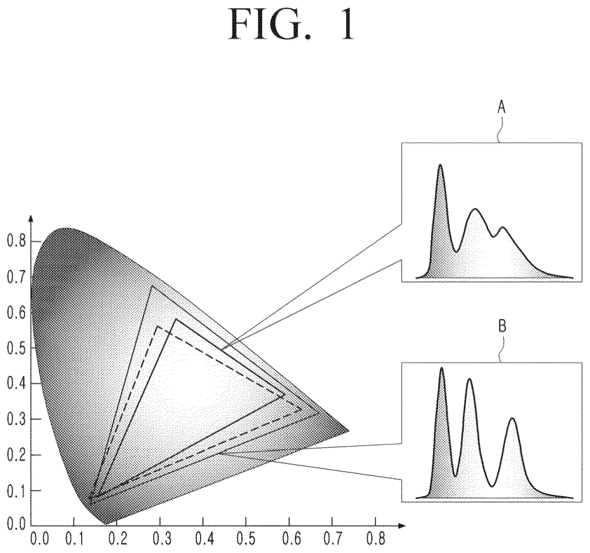

FIG. 1 is a diagram illustrating spectrum characteristics of a display to assist in the understanding of the disclosure.

A color reproducibility (or a color gamut) of a display is a representation of how much the display was able to reproduce a natural color. It may be displayed in a percentage by comparing with a standard colorimetric system CIE 1931 color gamut of an American television system committee (NTSC)

In related technologies, the color reproducibility may be high because R, G, and B is more clearly distinguished from colors output from the display. That is to say, the spectrum characteristics are narrow as primary colors may be expressed more clearly so long as the colors are not mixed.

As shown in FIG. 1, spectrum A of a typical display which provides an average color reproducibility may have all the R, G, and B wavelengths despite each of the wavelengths not being clearly distinguished. On the other hand, spectrum B of a wide color gamut display which provides a relatively wide color reproducibility may be clearly distinguished by each R, G, and B colors. In spectrum B, colors that cannot be mixed may be expressed, and a color close to a monochromatic color may be positioned at an edge of a color coordinate system. That is, a larger triangle may be drawn from a left color coordinate system, and that the color reproducibility may be relatively high.

The spectrum expressed in the display may stimulate red/green/blue cone cells in the eyes of a person and the person may recognize color. A function modelling a degree to which each cone cell is stimulated in the spectrum may be referred to as a color matching function (CMF). However, the wide color gamut display has a narrow spectrum characteristic unlike a typical display, and when considering that each person has a different visual characteristic (e.g., different degrees of stimulation with respect to an individual's cone cells), a degree to which each person perceives the same color as a different color in the wide color gamut display may increase.

Accordingly, various embodiments of correcting color by identifying the most optimal CMF to users to resolve a color mismatch phenomenon which occurs in the wide color gamut display will be described below.

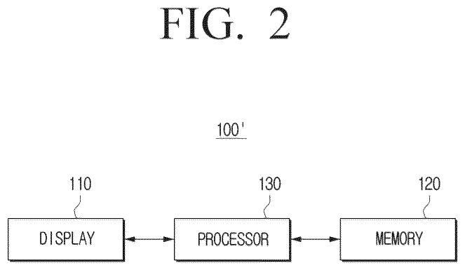

FIG. 2 is a block diagram illustrating a configuration of an electronic device according to an embodiment.

Referring to FIG. 2, an electronic device 100 may include a display 110, a memory 120, and a processor 130.

The electronic device 100 may be implemented as a TV, but is not limited thereto, and may be applicable without limitation so long as it is a device with picture processing and/or a display function such as, for example, and without limitation, a smart phone, a tablet personal computer (PC), a notebook PC, a monitor PC, a camera, a camcorder, a large format display (LFD), a digital signage, a digital information display (DID), a video wall, and the like.

The display 110 may be implemented as a display including self-emissive devices or a display including non-emissive devices and a backlight. For example, the display 110 may be implemented as a display of various types such as, for example, and without limitation, a liquid crystal display (LCD), an organic light emitting diode (OLED) display, light emitting diodes (LED), a plasma display panel (PDP), a quantum dot light emitting diodes (QLED), or the like. In the display 110, a driving circuit, which may be implemented in the form of an a-si TFT, a low temperature poly silicon (LTPS) TFT, an organic TFT (OTFT), or the like, a backlight unit, and the like may be included. Meanwhile, the display 110 may be implemented as a touch screen coupled with a touch sensor, a flexible display, a rollable display, a three-dimensional display (3D display), a display physically connected with a plurality of display modules, or the like. According an example, the display 110 may be implemented as the wide color gamut display.

The memory 120 may be electrically connected with the processor 130, and store data necessary for the various embodiments of the disclosure. The memory 120 may be implemented in a form of a memory embedded in the electronic device 100 according to a data storage use, and/or in a form of a memory attachable to or detachable from the electronic device 100. For example, data for the driving of the electronic device 100 may be stored in the memory embedded in the electronic device 100, and data for an expansion function of the electronic device 100 may be stored in the memory attachable to or detachable from the electronic device 100. Meanwhile, the memory embedded in the electronic device 100 may be implemented as at least one or more of a volatile memory (e.g., a dynamic RAM (DRAM), a static RAM (SRAM), or a synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard drive or a solid state drive (SSD)). In addition, the memory attachable to or detachable from the electronic device 100 may be implemented in a form such as one or more of, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

According to an example, the memory 120 may store at least one instruction for controlling the electronic device 100 or a computer program including instructions. According to another example, the memory 120 may store a picture, that is, an input picture received from an external device (e.g., a source device), an external storage medium (e.g., a USB), an external server (e.g., WEBHARD), and the like. Alternatively, the memory 120 may store a picture obtained through a camera (not shown) provided in the electronic device 100. According to still another example, the memory 120 may store various information necessary in image quality processing, for example, information, an algorithm, an image quality parameter, and the like to perform at least one from among a noise reduction, a detail enhancement, a tone mapping, a contrast enhancement, a color enhancement, or a frame rate conversion.

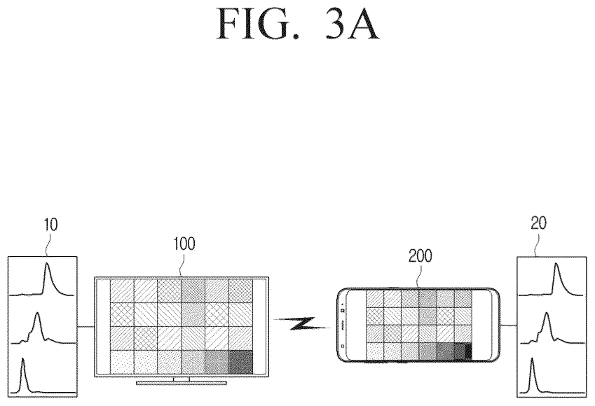

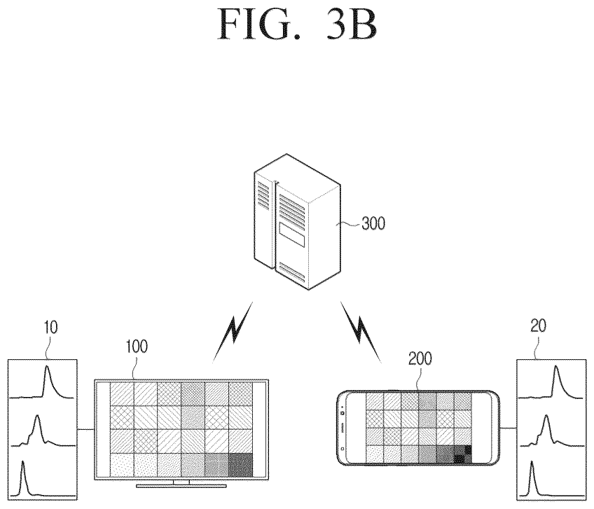

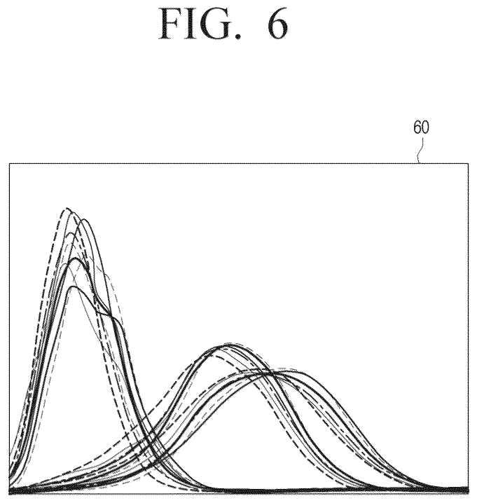

According to an embodiment, the memory 120 may store first spectrum information of the display 110, and information on a plurality of color matching functions (CMF). Here, the first spectrum information may mean unique spectrum information of a device reflected with the characteristics of the display 110. For example, the first spectrum information may be obtained by measuring a spectroscopic spectrum for a maximum R/G/B pixel value in the display 110 through a spectrum analyzer (or a spectrometer). The above may be in a form 10 as shown in FIG. 3A and FIG. 3B. The plurality of CMFs may be different types from one another, and various types of CMF already in existence may be included therein. For example, the plurality of CMFs may be in a form 60 as shown in FIG. 6.

According to an embodiment, the memory 120 may be implemented as a single memory configured to store data generated from various operations according to the disclosure. However, according to another embodiment, the memory 120 may be store different types of data each, or implemented to include a plurality of memories configured to each store data generated from different steps.

In the above-described embodiment, various data has been described as being stored in an external memory 120 of the processor 130, but at least a portion from among the above-described data may be stored in a memory inside the processor 130 according to at least one implementation of the electronic device 100 or the processor 130.

The at least one processor 130 (hereinafter, referred to as ‘processor’) control the overall operation of the electronic device 100 by being electrically connected with the memory 120. The at least one processor 130 may be configured to be one processor or a plurality of processors. Here, the one or plurality of processors may be implemented with at least one software or at least one hardware or a combination of at least one software and at least one hardware. According to an example, software or hardware logic relevant to the at least one processor may be implemented in one chip. According to another example, the software or hardware logic relevant to a portion from among the plurality of processors may be implemented in one chip and the software or hardware logic relevant to the remaining may be implemented in another chip.

Specifically, the processor 130 may perform, by executing at least one instruction stored in the memory 120, an operation of the electronic device 100 according to the various embodiments of the disclosure.

According to an embodiment, the processor 130 may be implemented as the digital signal processor (DSP) that processes digital picture signals, the microprocessor, a graphics processing unit (GPU), an artificial intelligence (AI) processor, a neural processing unit (NPU), or a time controller (TCON). However, the embodiment is not limited thereto, and may include one or more from among a central processing unit (CPU), a micro controller unit (MCU), a micro processing unit (MPU), a controller, an application processor (AP), a communication processor (CP), or an ARM processor, or may be defined by the relevant term. In addition, the processor 130 may be implemented as a System on Chip (SoC) or a large scale integration (LSI) embedded with a processing algorithm, and may be implemented in a form of an application specific integrated circuit (ASIC), or a field programmable gate array (FPGA).

In addition, according to an embodiment, the processor 130 for executing a neural network model may be implemented through a combination of software and a generic-purpose processor such as the CPU, the AP, and the DSP, or a graphics dedicated processor such as the GPU and a vision processing unit (VPU), or an artificial intelligence dedicated processor such as the NPU. The processor 130 may control for input data to be processed according to a pre-defined operation rule or a neural network model stored in the memory 120. Alternatively, if the processor 130 is a dedicated processor (or the artificial intelligence dedicated processor), the dedicated processor may be designed to a hardware structure specializing in the processing of a specific neural network model. For example, a hardware specializing in the processing of a specific neural network model may be designed as hardware chips such as ASIC or FPGA. If the processor 130 is implemented as a dedicated processor, the processor may be implemented to include a memory for implementing an embodiment of the disclosure, or implemented to include a memory processing function for using an external memory.

According to an embodiment, the processor 130 may obtain second spectrum information 20 of an external display device that displays a test image as shown in FIG. 3A and FIG. 3B. Here, the second spectrum information 20 may be unique spectrum information of a device reflected with the characteristics of an external display device 200 (or sub display device). For example, the second spectrum information 20 may obtain a spectroscopic spectrum for a maximum R/G/B pixel value in the external display device 200 by measuring through the spectrum analyzer (or spectrometer). In addition, the test image may be implemented in various forms such as, for example, and without limitation, a pattern image, a color chart image, a one-color image, a patch image, a normal image, and the like.

According to an example, the processor 130 may receive the second spectrum information 20 of the external display device 200 as shown in FIG. 3A directly from the external display device 200. According to another example, the processor 130 may receive the second spectrum information 20 of the external display device 200 from another external device such as an external server 300 as shown in FIG. 3B. Here, the external display device 200 may be implemented into devices of various types that include the display like the electronic device 100. For example, the external display device 200 may be implemented as a smart phone, a tablet personal computer (PC), a notebook PC, a monitor, a PC, a camera, a camcorder, a large format display (LFD), a digital signage, a digital information display (DID), a video wall, and the like. However, for convenience of description below, it will be described assuming that the electronic device 100 is implemented as a TV, and the external display device 200 is implemented as a smart phone.

According to an example, first spectrum information 10 and second spectrum information 20 may be represented as shown in Equation 1 and Equation 2 below.

$${SPD}_{Disp 1 Max} = ( \overline{{R}_{Disp 1 Max}} \overline{{G}_{Disp 1 Max}} \overline{{B}_{Disp 1 Max}} ) \qquad Eqn ( 1 )$$

$$and$$

$${SPD}_{Disp 2 Max} = ( \overline{{R}_{Disp 2 Max}} \overline{{G}_{Disp 2 Max}} \overline{{B}_{Disp 2 Max}} ) \qquad ( 2 )$$

Here, SPD_{Disp1Max} may represent spectrum information of each of Max R/G/B of the display 110, and SPD_{Disp2Max} may represent spectrum information of each of Max R/G/B of the external display device 200.

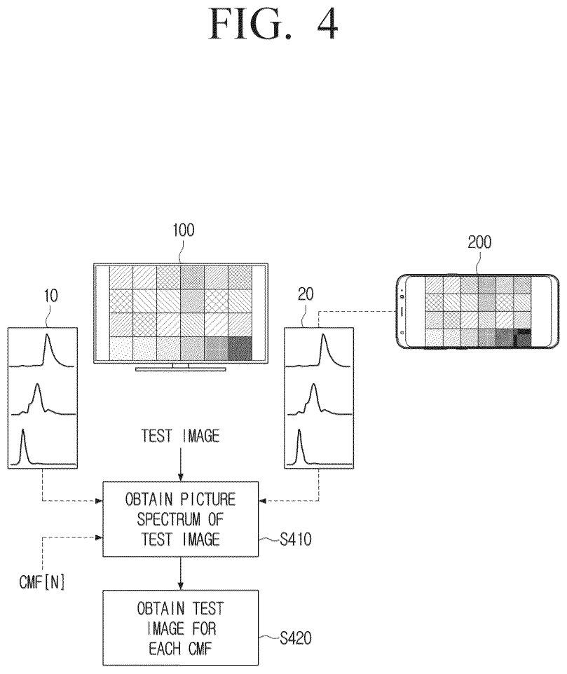

FIG. 4 is a diagram illustrating a test image obtaining method for each CMF according to an embodiment.

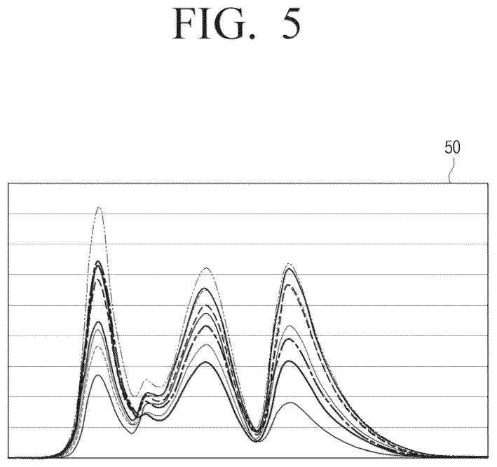

Referring to FIG. 4, the processor 130 may obtain picture spectrum information of a test image based on the second spectrum information 20 (S410). Here, the picture spectrum information may be obtained by applying the second spectrum information 20 to a pixel value of the test image. For example, the picture spectrum information may be obtained by multiplying the second spectrum information 20 to the pixel value of the test picture. FIG. 5 is a diagram illustrating picture spectrum information 50 of a test picture according to an embodiment. According to an example, the picture spectrum information 50 of the test picture displayed in the external display device 200 may be calculated as in Equation 3 below.

$${SPD}_{Disp 2} [ M ] = {SPD}_{Disp 2 MAX} \times ( \begin{matrix}{R}_{Disp 2} [ M ] \\ {G}_{Disp 2} [ M ] \\ {B}_{Disp 2} [ M ]\end{matrix} ) \qquad Eqn ( 3 )$$

Here, M represents a number of colors used in the test image.

Here, the processor 130 may obtain test images for each of the plurality of CMFs (S420). FIG. 6 is a diagram illustrating a plurality of CMF information 60 according to an embodiment. The processor 130 may obtain a test image corresponding to each of the plurality of CMFs 60.

Specifically, the processor 130 may obtain test images for each of the plurality of CMFs corresponding to the test image based on the picture spectrum information 50, the first spectrum information 10, and the plurality of CMF information 60 obtained based on the second spectrum information 20 (S430).

According to an example, the plurality of CMF information 60 may be calculated as in Equation 4 below.

$$CMF [ N ] = ( \begin{matrix}\overline{L [ N ]} & \overline{M [ N ]} & \overline{S [ N ]}\end{matrix} ) \qquad Eqn ( 4 )$$

Here, N may mean a number of pre-defined CMFs.

According to an embodiment, the processor 130 may obtain test images, that is, an N-number of test images, corresponding to the display 110 for each of an N-number of CMFs for each of the test pictures provided in the external display device 200. For example, if the test pictures are an M-number, because test images corresponding to the display 110 for N-number of CMFs for each of the M-number of test pictures can be obtained, a total of M*N-number of test images may be obtained.

Meanwhile, the processor 130 may control, based on test images for each of the plurality of CMFs being obtained, the display 110 to display a plurality of test images according to a pre-set method.

An exemplary method of obtaining test images for each of the plurality of CMFs will be described in greater detail below.

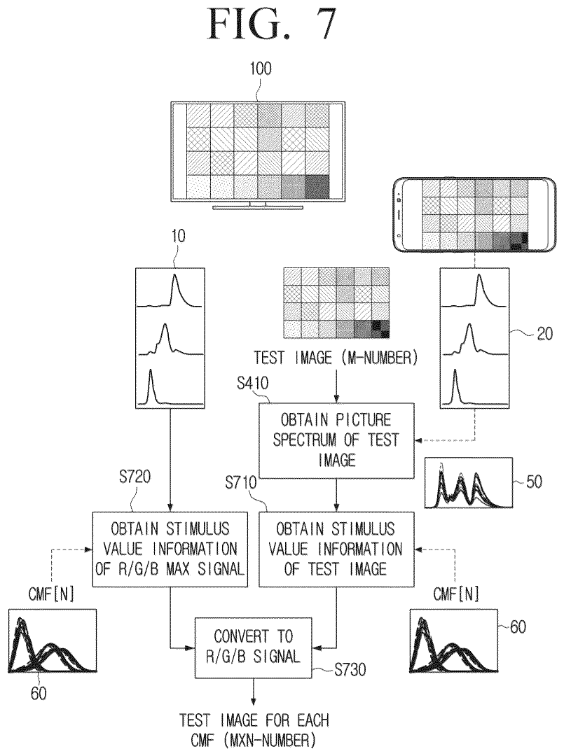

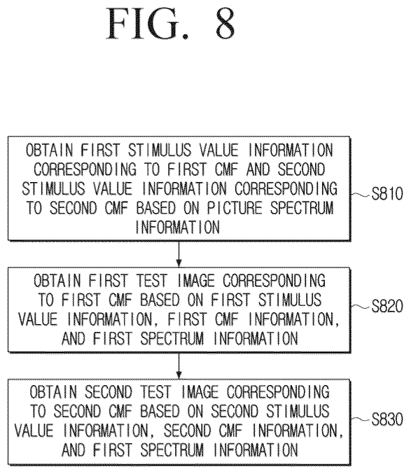

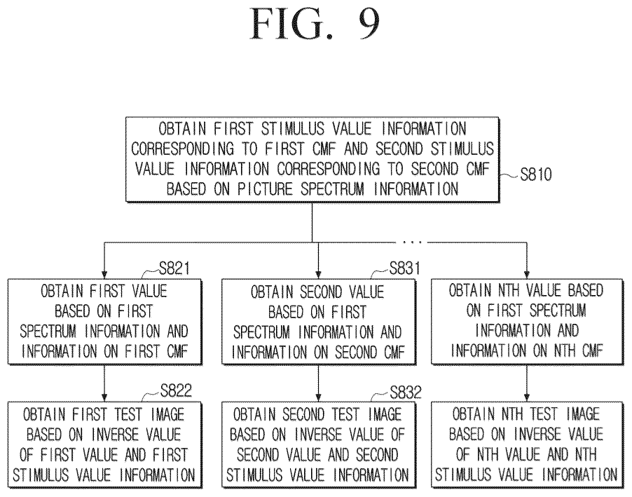

FIG. 7, FIG. 8, and FIG. 9 are diagrams illustrating methods for obtaining test images for each of a plurality of CMFs according to an embodiment.

According to an embodiment shown in FIG. 7, the processor 130 may obtain picture spectrum information of a test image based on the second spectrum information 20 (S410). Then, the processor 130 may obtain stimulus value information corresponding to each of the plurality of CMFs 60 based on the picture spectrum information 50 obtained based on the second spectrum information 20 (hereinafter, referred to as ‘stimulus value A’) (S710). Here, the stimulus value information may mean a degree of reaction by optical cone cells, that is, an L cell, an M cell, and an S cell, which distinguish colors present in retinas. For example, the L cell, the M cell, and the S cell may be photoreceptor cells that respectively react sensitively to rays of a long wavelength near a red color, an intermediate wavelength near a green color, and a short wavelength near a blue color, and degrees to which the three cells of LMS react according to frequencies of the rays may vary respectively. Accordingly, the stimulus value information may be referred as LMS information.

In addition, the processor 130 may obtain stimulus value information based on the first spectrum information 10 and the plurality of CMFs 60 (hereinafter, referred to as ‘stimulus value B’) (S720). However, because the pixel value of the test picture necessary for obtaining stimulus value B is a value which is to be lastly obtained, the stimulus value B may not be obtained in operation S720, and the pixel value of the test picture in an equation obtaining the stimulus value B may be an unknown.

Then, the processor 130 may obtain pixel values, that is, R/G/B signals, of the test picture based on the equation for obtaining stimulus value A obtained in operation S710 and the stimulus value B obtained in operation S720 (S730). Accordingly, test images for each of the CMFs may be obtained.

Specifically, because the stimulus value A of the display 110 and the stimulus value B of the external display device 200 are identically transferred to the eyes of the user, the pixel value of the test picture which is unknown in operation S720 may be obtained under the assumption that the stimulus value A and the stimulus value B are the same.

Accordingly, the processor 130 may obtain the pixel value of the test picture which is unknown based on the first spectrum information and information on each of the plurality of CMFs known for obtaining the stimulus value A obtained in operation S710 and the stimulus value B in operation S720. That is, the processor 130 may obtain the plurality of test images based on the stimulus value A, the first spectrum information, and information on each of the plurality of CMFs.

For example, the stimulus value A which represents the first spectrum information of the display 110 being transferred to the eyes through the CMF may be obtained based on Equation 5 below.

$${LMS}_{Disp 1} [ N ] [ M ] = {CMF [ N ]}^{T} {SPD}_{Disp 1 MAX} \times ( \begin{matrix}{R}_{Disp 1} [ M ] \\ {G}_{Disp 1} [ M ] \\ {B}_{Disp 1} [ M ]\end{matrix} ) \qquad Eqn ( 5 )$$

In addition, the stimulus value B which represents the second spectrum information of the external display device 200 being transferred to the eyes through the CMF may be obtained based on Equation 6 below.

$${LMS}_{Disp 2} [ N ] [ M ] = {CMF [ N ]}^{T} {SPD}_{Disp 2} [ M ] \qquad Eqn ( 6 )$$

Because the stimulus value A of the display 110 and the stimulus value B of the external display device 200 are identically transferred to the eyes of the user, a relationship as in Equation 7 below may be established.

$${LMS}_{Disp 1} [ N ] [ M ] = {CMF [ N ]}^{T} {SPD}_{Disp 1 MAX} \times ( \begin{matrix}{R}_{Disp 1} [ M ] \\ {G}_{Disp 1} [ M ] \\ {B}_{Disp 1} [ M ]\end{matrix} ) = {LMS}_{Disp 2} [ N ] [ M ] \qquad Eqn ( 7 )$$

The pixel values of the test image corresponding to the display 110, that is, R_{Disp1}[M], G_{Disp1}[M], B_{Disp1}[M] from Equation 7 above may be calculated based on Equation 8 below.

$$( \begin{matrix}{R}_{Disp 1} [ M ] \\ {G}_{Disp 1} [ M ] \\ {B}_{Disp 1} [ M ]\end{matrix} ) = {( {CMF [ N ]}^{T} {SPD}_{Disp 1 MAX} )}^{- 1} \times {LMS}_{Disp 2} [ N ] [ M ] \qquad Eqn ( 8 )$$

The above-described description may be summarized as the flowcharts shown in FIG. 8 and FIG. 9.

Referring to FIG. 8, the processor 130 may obtain first stimulus value information corresponding to a first CMF, and obtain second stimulus value information corresponding to a second CMF from among the plurality of CMFs based on the obtained picture spectrum information (S810).

Then, the processor 130 may obtain a first test image corresponding to the first CMF based on the first stimulus value information, information on the first CMF, and the first spectrum information (S820). In addition, the processor 130 may obtain a second test image corresponding to the second CMF based on the second stimulus value information, information on the second CMF, and the first spectrum information (S830). The obtaining of the first test image (S820) and the second test image (S830) may be performed sequentially, but the disclosure is not limited thereto. For example, obtaining of the first test image (S820) and the second test image (S830) may be performed in parallel.

According to an example, the processor 130 may obtain a first value based on the first spectrum information and information on the first CMF as shown in FIG. 9 (S821), and obtain the first test image based on an inverse value of the first value and the first stimulus value information (S822). In addition, the processor 130 may obtain a second value based on the first spectrum information and information of the second CMF (S831), and obtain the second test image based on an inverse value of the second value and the second stimulus value information (S832). In the same method, an nth test image corresponding to an nth CMF may be obtained based on nth stimulus value information corresponding to an nth CMF, nth CMF information, and the first spectrum information.

In the method described above, test images corresponding to the display 110 for each of the N-number of CMFs, that is, N-number of test images, may be obtained for each of the test pictures provided in the external display device 200. For example, if the test pictures are an M-number, because test images corresponding to the display 110 for the N-number of CMFs for each of the M-number of test pictures can be obtained, a total of M*N-number of test images may be obtained.

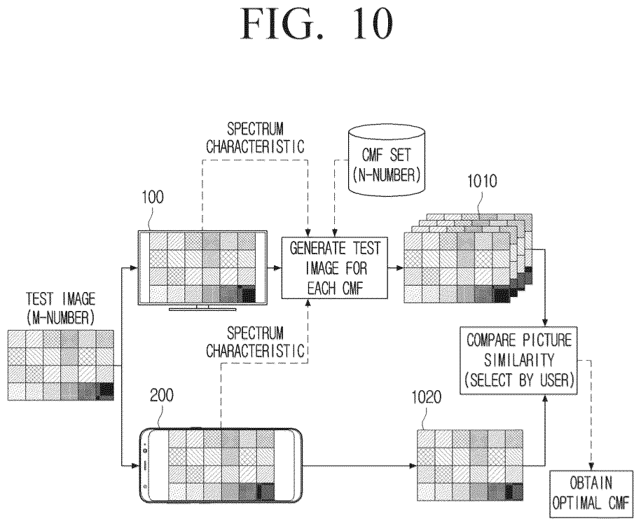

Meanwhile, the processor 130 may control, based on test images for each of the plurality of CMFs being obtained, the display 110 to display a user interface (UI) screen for selecting one from among the obtained test images. For example, as shown in FIG. 10, a user may compare test images 1010 for each of the plurality of CMFs displayed in the display 110 and a test image 1020 displayed in the external display device 200 and select the test image. Accordingly, if one from among the test images 1010 for each of the plurality of CMFs displayed in the display 110 is selected, an optimal CMF information (user CMF) may be obtained for the user based on the selected test image.

According to an embodiment, the processor 130 may consecutively display at least one from among the test images for each of the plurality of CMFs while a test image is being displayed in the external display device 200. In addition, the processor 130 may identify any one from among the test images for each of the plurality of CMFs based on a user input received while at least one from among the test images for each of the plurality of CMFs is being displayed. The processor may 130 identify the CMF corresponding to the identified test image as a CMF corresponding to a cognitive characteristic of a user (user CMF).

According to an example, the processor 130 may display, while the test image is being displayed in the external display device 200, a first UI screen including the first test image and the second test image from among the test images for each of the plurality of CMFs. Then, the processor 130 may consecutively display a second UI screen including the first test image and a third test image. In the same or another embodiment, the processor 130 may display, while the test image is being displayed in the external display device 200, the first UI screen including the first test image and the second test image from among the test images for each of the plurality of the CMFs. Then, the processor 130 may consecutively display a third UI screen including the third test image and a fourth test image.

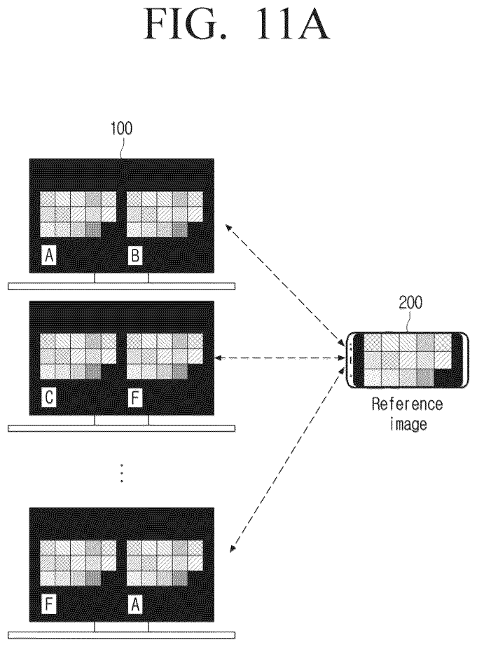

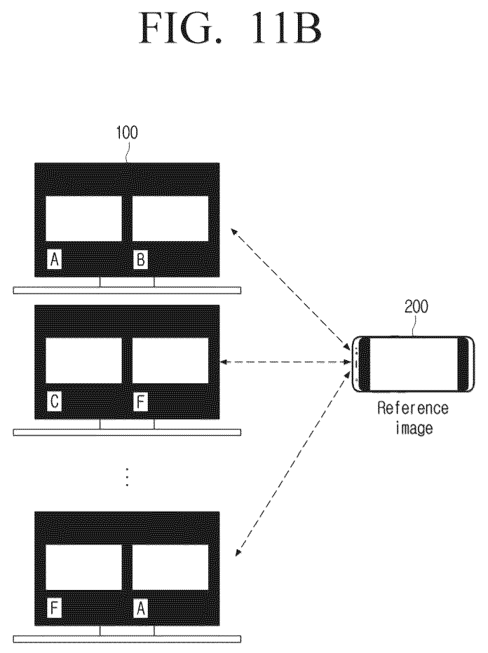

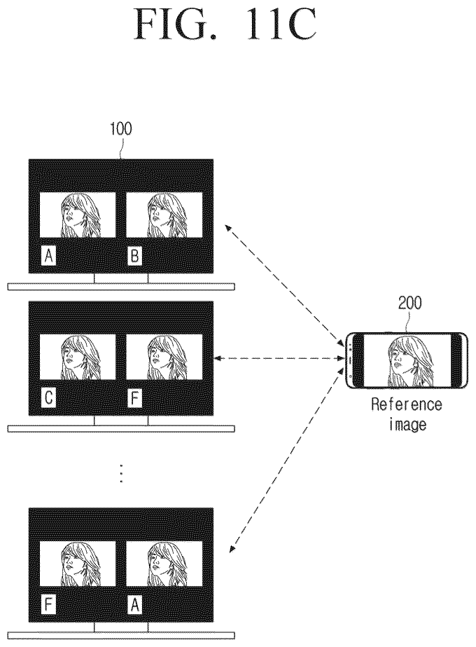

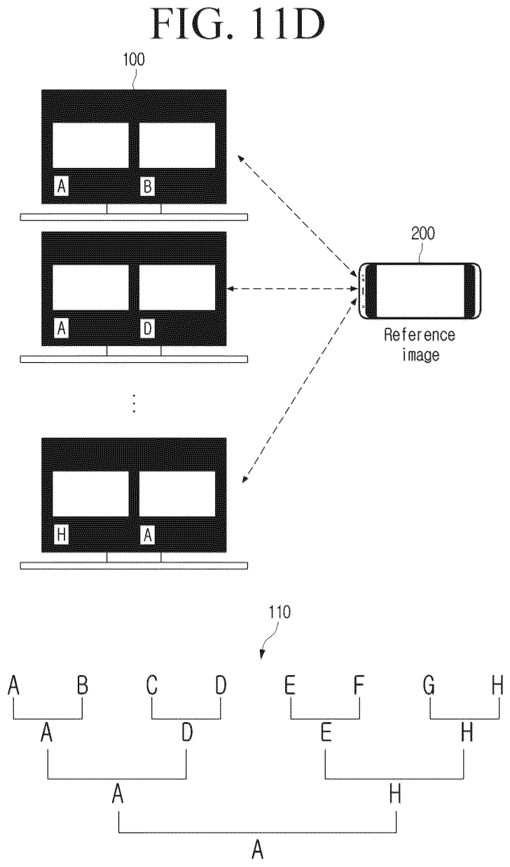

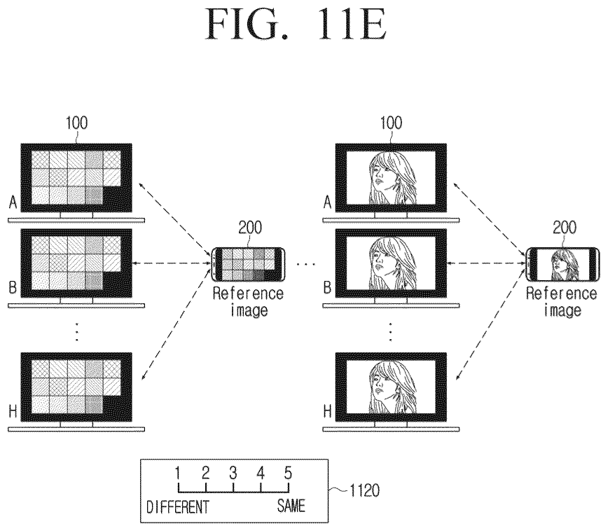

FIG. 11A to FIG. 11E are diagrams illustrating an example of a UI screen according to an embodiment.

FIG. 11A, FIG. 11B, and FIG. 11C show an embodiment (a full comparison method) of consecutively providing all combinations (or pairs) of the test images for each of the plurality of CMFs in the electronic device 100 while a reference test image is provided in the external display device 200 according to an embodiment. For example, all combinations such as (test image A, test image B)→(test image C, test image D)→(test image E, test image F) . . . → . . . (test image F, test image A) may be consecutively provided. FIG. 11A is an example of the test image being a color chart image, FIG. 11B is an example of the test image being a patch image of one color, and FIG. 11C is an example of the test image being a normal image. The user may select an image which appears to be most identical or similar to the reference test image in the external display device 200 from among the test images provided in the electronic device 100, and the processor 130 may identify the CMF information corresponding to the selected image as CMF information optimized to the user. For example, the processor 130 may identify the CMF information corresponding to the test image selected by the most number of times as CMF information optimized to the user.

While FIG. 11A to FIG. 11C are described as two image pairs being simultaneously provided in one UI screen, the embodiment is not limited thereto, and the two image pairs may be provided with a time difference therebetween.

FIG. 11D shows an embodiment (a tournament method) of consecutively providing combinations of test images for each of the plurality of CMFs in the electronic device 100 while the reference test image is provided in the external display apparatus 200 according to another example. The fundamental method is similar to the process show in FIG. 11A to FIG. 11C, but rather than providing all pairs, test images may be provided in the tournament method 1110 by excluding images which were not selected. A faster result may be obtained than from the method shown in FIG. 11A to FIG. 11C.

FIG. 11E shows an embodiment (a rating method) of consecutively providing a single test image rather than providing pairs of test images and measuring a score by the user according to still another example. For example, the electronic device 100 may provide a UI 1120 with which a similarity score for the displayed test images may be measured together with the test image. In this case, the user may select a score through the UI 1120 based on a similarity with the reference test image provided in the external display device 200 and the test images provided in the electronic device 100. For example, the user may select the lowest score (1 score) for a test image which is most different, and select the highest score (5 score) for the most identical test image, but the disclosure is not limited to herein.

Meanwhile, the processor 130 may identify, based on one from among the test images for each of the plurality of CMFs being determined according to the various embodiments described above, the CMF information corresponding to the determined test image as CMF information optimized to the user (hereinafter, referred to as a ‘user CMF information’).

Then, the processor 130 may obtain an output picture by correcting an input picture input in the electronic device 100 based on the identified user CMF information.

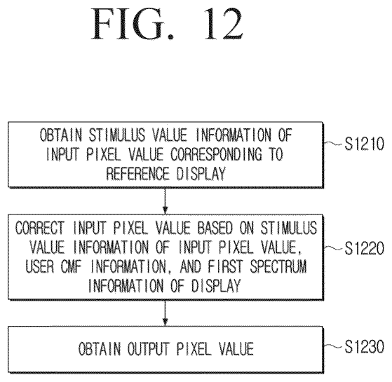

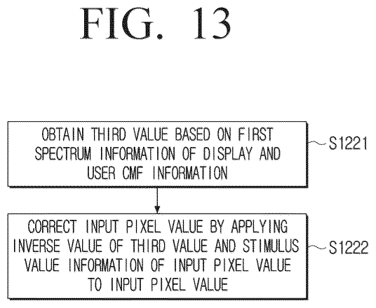

FIG. 12 and FIG. 13 are diagrams illustrating a method for correcting an input picture according to an embodiment.

According to an embodiment shown in FIG. 12, the processor 130 may obtain stimulus value information of an input pixel value corresponding to a reference display based on the user CMF information and third spectrum information of the reference display (hereinafter, referred to as ‘stimulus value C’) (S1210). Here, the reference display may be a target display used in picture production, and the like. The third spectrum information of the reference display may include spectroscopic spectrum characteristic information of the reference display for the maximum R/G/B pixel value. When stimulus value C of the reference display is used, a color cognitively similar with the reference display may be implemented in the display 110.

Then, the processor 130 may correct the input pixel value based on the stimulus value C of the input pixel value, the user CMF information, and the first spectrum information of the display 110 (S1220), and obtain an output pixel value (S1230).

Specifically, according to an embodiment shown in FIG. 13, the processor 130 may obtain a third value based on the first spectrum information of the display 110 and the user CMF information (S1221), and correct the input pixel value by applying an inverse value of the third value and the stimulus value C of the input pixel value to the input pixel value (S1222).

According to an example, a stimulus value information of the reference display, that is, the stimulus value C, may be calculated based on Equation 9 below.

$${LMS}_{Ref} = {CMF [ k ]}^{T} {SPD}_{REFMax} ( \begin{matrix}{R}_{IN} \\ {G}_{IN} \\ {B}_{IN}\end{matrix} ) \qquad Eqn ( 9 )$$

Here, SPD_{REFMax} may represent the third spectrum information of the reference display, and LMS_{Ref} may represent the stimulus value information of the reference display, that is, the stimulus value C.

Assuming that the target display, that is, stimulus value information for the R/G/B pixel values output from the display 110 of the electronic device 100 is the same as the stimulus value information of the reference display, Equation 10 below may be established.

$${LMS}_{Target} = {CMF [ k ]}^{T} {SPD}_{TargetMax} ( \begin{matrix}{R}_{OUT} \\ {G}_{OUT} \\ {B}_{OUT}\end{matrix} ) = LM \text{?} \qquad Eqn ( 10 )$$

$$\text{?} \text{indicates text missing or illegible when filed}$$

Here, SPD_{TargetMax} may mean the target display, for example, the first spectrum information of the display 110, and LMS_{Target} may mean the stimulus value information of the target display, that is, a stimulus value of the display 110.

Based on Equation 10, the output pixel value may be calculated as in Equation 11 below.

$$( \begin{matrix}{R}_{OUT} \\ {G}_{OUT} \\ {B}_{OUT}\end{matrix} ) = {( {CMF [ k ]}^{T} {SPD}_{TargetMax} )}^{- 1} ( {CMF [ k ]}^{T} {SPD}_{REFMax )} ( \begin{matrix}{R}_{IN} \\ {G}_{IN} \\ {B}_{IN}\end{matrix} ) \qquad Eqn ( 11 )$$

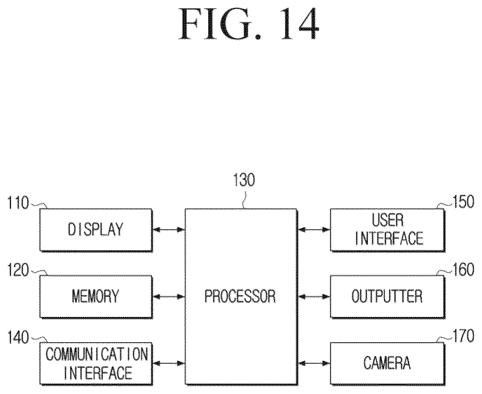

FIG. 14 is a diagram illustrating an embodiment of an electronic device according to an embodiment of the disclosure.

Referring to FIG. 14, an electronic device 100′ may include the display 110, the memory 120, the processor 130, a communication interface 140, a user interface 150, an outputter 160, and a camera 170. Detailed descriptions for configurations that overlap with the configurations shown in FIG. 2 from among the configurations shown in FIG. 14 will be omitted.

The communication interface 140 may be an element which performs communication with an external device. For example, the communication interface 140 may receive input of a picture signal in a streaming or download method from an external device (e.g., source device), an external storage medium (e.g., USB memory), an external server (e.g., WEBHARD), or the like through a communication method such as, for example, and without limitation, an AP based Wi-Fi (e.g., Wi-Fi, wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like. Here, the picture signal may be any one digital picture signal from among a standard definition (SD), a high definition (HD), a Full HD or an Ultra HD picture, but is not limited thereto.

The user interface 150 may be implemented with a device such as a button, a touch pad, a mouse and a keyboard, or implemented as a touch screen, a remote controller transceiver, and the like capable of performing the above-described display function and the operation input function together therewith. The remote controller transceiver may receive remote controller signals from an external remote controlling device, or transmit a remote controller signal through at least one communication method form among an infrared communication, a Bluetooth communication, or a Wi-Fi communication.

The outputter 160 may output sound signals. For example, the outputter 160 may convert digital sound signals processed in the processor 130 to analog sound signals, amplify and output the same. For example, the outputter 160 may include at least one speaker unit, a D/A converter, an audio amplifier, and the like through which at least one channel may be output. According to an example, the outputter 160 may be implemented to output various multi-channel sound signals. In this case, the processor 130 may control the outputter 160 to enhance process and output the input sound signals to correspond to an enhance processing of the input picture. For example, the processor 130 may convert the input two-channel sound signal to a virtual multi-channel (e.g., 5.1 channel) sound signal, or process to stereo sound signal optimized to a space by recognizing a position at which the electronic device 100′ is placed, or provide a sound signal optimized according to a type of an input picture (e.g., a genre of content).

The camera 170 may perform capturing by being turned-on according to a pre-set event. The camera 170 may convert a captured picture to an electric signal, and generate picture data based on the converted signal. For example, a subject may be converted to an electric picture signal through a semiconductor optical device (a charged coupled device (CCD)), and the picture signal converted as described above may be signal processed after being amplified and converted to a digital signal.

The electronic device 100′ may additionally include a tuner and a demodulator according to an embodiment. The tuner (not shown) may receive radio frequency (RF) broadcast signals by tuning a channel selected by the user or by tuning all pre-stored channels from among the RF broadcast signals received through an antenna. The demodulator (not shown) may receive and demodulate digital IF (DIF) signals converted from the tuner, and perform channel decoding, and the like. According to an embodiment, an input picture received through the tuner may be provided to the processor 130 for shadow processing according to an embodiment of the disclosure after being processed through the demodulator (not shown).

According to the various embodiments described above, the color mismatch phenomenon that can occur in the wide color gamut display, in which implementing accurate colors with existing standard-based quantitative calibration is difficult, may be solved.

The various embodiments of the disclosure may be applied to not only the electronic device, but to all electronic devices capable of processing pictures such as a picture receiving device such as a set top box or a display device such as a TV.

Meanwhile, methods according to the various embodiments of the disclosure described above may be implemented in an application form installable in electronic devices. Alternatively, methods according to the various embodiments of the disclosure described above may be performed using a deep-learning based artificial neural network model (or a deep artificial neural network), that is, a training network model. According to an example, based on the picture spectrum information, the first spectrum information, and information on the plurality of CMFs described above being input in a neural network model, test images for each of the plurality of CMFs may be obtained using the neural network model trained to output test images for each of the plurality of CMFs. According to another example, if the test image, the second spectrum information, the first spectrum information, and information of the plurality of CMFs are input in the neural network model, test images for each of the plurality of CMFs may be obtained using the neural network model trained to output the test images for each of the plurality of CMFs. The neural network model being trained may mean a pre-defined operation rule or a neural network model set to perform a desired characteristic (or, object) being created as a basic neural network model (e.g., a neural network model including arbitrary random parameters is trained by a learning algorithm using a plurality of training data. The training as described above may be carried out through a separate server and/or a system, but is not limited thereto, and may be carried out in the electronic device 100. Examples of a learning algorithm may include a supervised learning, an unsupervised learning, a semi-supervised learning, or a reinforcement learning, but are not limited to the above-described examples. Here, the neural network model may be implemented as, for example, and without limitation, a Deep Neural Network (DNN), and examples thereof may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, or the like, but is not limited to the above-described examples.

In addition, at least a portion from among the various embodiments of the disclosure described above may be implemented with only a software upgrade or a hardware upgrade of the electronic devices.

In addition, at least a portion from among the various embodiments of the disclosure described above may be performed through an embedded server provided in the electronic device 100, or through an external server of the electronic device 100.

Meanwhile, according to an embodiment of the disclosure, the various embodiments described above may be implemented with software including instructions stored in a machine-readable storage media (e.g., a computer). The machine may call an instruction stored in the storage medium, and as a device operable according to the called instruction, may include an electronic device (e.g., electronic device (A)) according to the above-mentioned embodiments. Based on a command being executed by the processor, the processor may directly or using other elements under the control of the processor perform a function corresponding to the command. The command may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, each of the elements (e.g., a module or a program) according to the various embodiments described above may be formed as a single entity or a plurality of entities, and a portion of the sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with various embodiments, may be executed consecutively, in a parallel, repetitively, or in a heuristic manner, or at least some operations may be executed in a different order, omitted or a different operation may be added.

While the disclosure has been illustrated and described with reference to various embodiments thereof, it will be understood that the various embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic device, comprising:
a display;
memory, the memory storing a first spectrum information of the display and information on a plurality of color matching functions (CMFs); and
at least one processor connected with the memory,
wherein the at least one processor is configured to:
obtain picture spectrum information of a test image based on a second spectrum information of an external display device displaying the test image,
obtain test images based on the picture spectrum information, the first spectrum information, and the information on the plurality of CMFs, wherein the test images comprise a respective test image for each of the plurality of CMFs corresponding to the test image, and
control the display to display the test images.

2. The electronic device of claim 1, wherein
the at least one processor is further configured to:
obtain first stimulus value information corresponding to a first CMF and second stimulus value information corresponding to a second CMF from among the plurality of CMFs based on the picture spectrum information,
obtain a first test image corresponding to the first CMF based on the first stimulus value information, information on the first CMF, and the first spectrum information, and
obtain a second test image corresponding to the second CMF based on the second stimulus value information, information on the second CMF, and the first spectrum information.

3. The electronic device of claim 2, wherein
the at least one processor is further configured to:
obtain a first value based on the first spectrum information and the information on the first CMF,
obtain the first test image based on a first inverse value of the first value and the first stimulus value information,
obtain a second value based on the first spectrum information and the information on the second CMF, and
obtain the second test image based on a second inverse value of the second value and the second stimulus value information.

4. The electronic device of claim 1, wherein
the at least one processor is further configured to:
obtain, based on an image from among the test images being selected according to a user input, stimulus value information of an input pixel value corresponding to a reference display, wherein the stimulus value information of the input pixel value is based on information on a CMF corresponding to the selected test image and third spectrum information of the reference display, and
obtain an output pixel value by correcting the input pixel value based on the stimulus value information of the input pixel value, the information on the CMF corresponding to the selected test image, and the first spectrum information.

5. The electronic device of claim 4, wherein
the at least one processor is further configured to:
obtain a third value based on the first spectrum information and the information on the CMF corresponding to the selected test image, and
obtain the output pixel value by multiplying a third inverse value of the third value and the stimulus value information of the input pixel value to the input pixel value.

6. The electronic device of claim 4, wherein the first spectrum information of the display comprises:
first spectroscopic spectrum characteristic information of the display for maximum R/G/B pixel values; and
wherein the third spectrum information of the reference display comprises:
reference spectroscopic spectrum characteristic information of the reference display for maximum R/G/B pixel values.

7. The electronic device of claim 1, wherein
the at least one processor is further configured to:
control, while the test image is being displayed in the external display device, the display to display one or more test images from among the test images,
identify an image from among the test images based on a user input received while the one or more test images are being displayed, and
identify a CMF corresponding to the identified test image as a CMF corresponding to a user recognition characteristic.

8. The electronic device of claim 7, wherein
the at least one processor is further configured to:
display, while the test image is being displayed in the external display device, a first user interface (UI) screen comprising a first test image and a second test image from among the test images, and then consecutively display a second UI screen comprising the first test image and a third test image from among the test images, or
display the first UI screen comprising the first test image and the second test image from among the test images, and then consecutively display a third UI screen comprising the third test image and a fourth test image.

9. The electronic device of claim 1, wherein
the at least one processor is further configured to:
obtain, for each of a first number of test images, a total of a second number of test images by obtaining test images for each of a third number of CMFs based on the first spectrum information, wherein the second number is a product of multiplication of the first number and the third number.

10. The electronic device of claim 1, wherein
the display is implemented as a wide color gamut display.

11. A control method of an electronic device, the method comprising:
identifying a first spectrum information of a display comprised in the electronic device;
obtaining picture spectrum information of a test image based on a second spectrum information of an external display device displaying the test image;
obtaining test images based on the picture spectrum information, the first spectrum information, and information on a plurality of color matching functions (CMFs), wherein the test images comprise a respective test image for each of the plurality of CMFs corresponding to the test image; and
displaying the test images on the display comprised in the electronic device.

12. The method of claim 11, wherein
the obtaining the test images for each of the plurality of CMFs comprises:
obtaining first stimulus value information corresponding to a first CMF and second stimulus value information corresponding to a second CMF from among the plurality of CMFs based on the picture spectrum information;
obtaining a first test image corresponding to the first CMF based on the first stimulus value information, information on the first CMF, and the first spectrum information; and
obtaining a second test image corresponding to the second CMF based on the second stimulus value information, information on the second CMF, and the first spectrum information.

13. The method of claim 12,
wherein the obtaining the first test image comprises:
obtaining a first value based on the first spectrum the information and information on the first CMF, and
obtaining the first test image based on an inverse value of the first value and the first stimulus value information, and
wherein the obtaining the second test image comprises:
obtaining a second value based on the first spectrum information and the information on the second CMF, and
obtaining the second test image based on an inverse value of the second value and the second stimulus value information.

14. The method of claim 1, further comprising:
obtaining, based on an image from among test images being selected according to a user input, stimulus value information of an input pixel value corresponding to a reference display, wherein the stimulus value information of the input pixel value is based on information on a CMF corresponding to the selected test image and third spectrum information of the reference display; and
obtaining an output pixel value by correcting the input pixel value based on the stimulus value information of the input pixel value, the information on the CMF corresponding to the selected test image, and the first spectrum information.

15. A non-transitory computer-readable medium storing one or more instructions that, when executed, cause at least one processor of an electronic device to:
identify a first spectrum information of a display comprised in the electronic device;
obtain picture spectrum information of a test image based on a second spectrum information of an external display device displaying the test image;
obtain test images based on the picture spectrum information, the first spectrum information, and information on a plurality of color matching functions (CMFs), wherein the test images comprise a respective test image for each of the plurality of CMFs corresponding to the test image,
display the test images on the display comprised in the electronic device.

16. The non-transitory computer-readable medium of claim 15, wherein the obtaining the test images for each of the plurality of CMFs comprises:
obtaining first stimulus value information corresponding to a first CMF and second stimulus value information corresponding to a second CMF from among the plurality of CMFs based on the picture spectrum information;
obtaining a first test image corresponding to the first CMF based on the first stimulus value information, information on the first CMF, and the first spectrum information; and
obtaining a second test image corresponding to the second CMF based on the second stimulus value information, information on the second CMF, and the first spectrum information.

17. The non-transitory computer-readable medium of claim 16,
wherein the obtaining the first test image comprises:
obtaining a first value based on the first spectrum the information and information on the first CMF, and
obtaining the first test image based on an inverse value of the first value and the first stimulus value information, and
wherein the obtaining the second test image comprises:
obtaining a second value based on the first spectrum information and the information on the second CMF, and
obtaining the second test image based on an inverse value of the second value and the second stimulus value information.

18. The non-transitory computer-readable medium of claim 15, wherein the one or more instructions further cause at least one processor of an electronic device to:
obtain, based on an image from among test images being selected according to a user input, stimulus value information of an input pixel value corresponding to a reference display, wherein the stimulus value information of the input pixel value is based on information on a CMF corresponding to the selected test image and third spectrum information of the reference display; and
obtain an output pixel value by correcting the input pixel value based on the stimulus value information of the input pixel value, the information on the CMF corresponding to the selected test image, and the first spectrum information.

19. The non-transitory computer-readable medium of claim 18, wherein the one or more instructions further cause at least one processor of an electronic device to:
obtain a third value based on the first spectrum information and the information on the CMF corresponding to the selected test image, and
obtain the output pixel value by multiplying a third inverse value of the third value and the stimulus value information of the input pixel value to the input pixel value.

20. The non-transitory computer-readable medium of claim 18, wherein the first spectrum information of the display comprises:
first spectroscopic spectrum characteristic information of the display for maximum R/G/B pixel values; and
wherein the third spectrum information of the reference display comprises:
reference spectroscopic spectrum characteristic information of the reference display for maximum R/G/B pixel values.
